(19) United States
(12) Patent Application Publication
(10) Pub. No.: US 2002/0140804 A1
(43) Pub. Date: Oct. 3, 2002

(54) Method and apparatus for audio/image speaker detection and locator

(75) Inventors: Antonio J. Colmenarez, Peekskill, NY (US); Hugo J. Strubbe, Yorktown Heights, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/822,121

(22) Filed: Mar. 30, 2001

(51) Int. Cl. H04N 7/14

(52) U.S. Cl. 348/14.08; 348/14.01

(57) ABSTRACT

A method and apparatus for a video conferencing system using an array of two microphones and a stationary camera to automatically locate a speaker and electronically manipulate the video image to produce the effect of a movable pan tilt zoom (“PTZ”) camera. Computer vision algorithms are used to detect, locate, and track people in the field of view of a wide-angle, stationary camera. The estimated acoustic delay obtained from a microphone array, consisting of only two horizontally spaced microphones, is used to select the person speaking. This system can also detect any possible ambiguities, in which case, it cam respond in a fail-safe way, for example, it can zoom out to include all the speakers located at the same horizontal position.

### BACKGROUND OF THE INVENTION

1. Technical Field

The present invention relates to a method and apparatus for a video conferencing system using an array of two microphones and a stationary camera to automatically locate a speaker and electronically manipulate the video image to produce the effect of a movable pan tilt zoom (“PTZ”) camera.

2. Related Art

Video conferencing systems which determine a direction of an audio source relative to a reference point are known. Video conferencing systems are one variety of visual display systems and commonly include a camera, a number of microphones, and a display. Some video conferencing systems also include the capability to direct the camera toward a speaker and to frame appropriate camera shots. Typically, users of a video conferencing system direct movement of the camera to frame appropriate shots. Existing commercial video conferencing systems use microphone arrays to automatically locate a speaker and drive a pan tilt zoom (“PTZ”) video camera. See, for example, (1) Patent Cooperation Treaty Application WO 99/60788, entitled “Locating an Audio Source”, and (2) U.S. Pat. No. 5,778,082 entitled “Method and Apparatus for Localization of an Acoustic Source”, issued on Jul. 7, 1998 to Chu et al., both documents incorporated herein by reference.

Unfortunately, it is problematic to accurately detect, locate, and track a speaker using an array of only two microphones which function in combination with a stationary video camera. Thus, there is a need for a method and apparatus for a video conferencing system using an array of two microphones to automatically locate a speaker and to then track the speaker using a stationary video camera.

### SUMMARY OF THE INVENTION

Computer vision algorithms are used to detect, locate, and track people in the field of view of a wide-angle, stationary video camera. The estimated acoustic delay obtained from a microphone array, consisting of only two horizontally spaced microphones, is used to select the person speaking. Assuming that no more than one speaker will be located at exactly the same horizontal position, the acoustic delay between the two microphones provides enough information to unambiguously locate the speaker. The system of the present invention can also detect any possible ambiguities, in which case, it can respond in a fail-safe way. For example, it can zoom out to include all the speakers located at the same horizontal position.

The audio and video processing steps are performed at an early stage, so that only two microphones and one stationary video camera are needed to locate and track the speaker. This approach reduces the requirements in both hardware and computation, and improves the overall system performance. For instance, this approach allows the video conferencing system to accurately track moving people regardless of whether they speak or not.

In a first general aspect, the present invention provides a video conferencing system comprising: an image pickup device for generating image signals representative of an image; an audio pickup device for generating audio signals representative of sound from an audio source; and a multimodal integration architecture system for processing said image signals and said audio signals to determine a direction of the audio source relative to a reference point.

In a second general aspect, the present invention provides a method comprising the steps of: generating, at an image pickup device, image signals representative of an image; generating, at an audio pickup device, audio signals representative of sound from an audio source; processing the image signals and the audio signals to determine a direction of the audio source relative to a reference point; manipulating the image signals to produce refined image signals; and outputting said refined image signals.

In a third general aspect, the present invention provides a video conferencing system comprising: two microphones for generating audio signals representative of sound from a speaker;

a video camera for generating video signals representative of a video image; an electronic pan tilt zoom system for manipulating video images to produce the visual effects of panning, tilting, and or zooming; a processor for processing the video signals and the audio signals to determine a direction of a speaker relative to a reference point and supplying control signals to the electronic pan tilt zoom system for producing images that include the speaker in the field of view of the camera, the control signals being generated based on the determined direction of the speaker; and a transmitter for transmitting audio and video signals for video conferencing.

### BRIEF DESCRIPTION OF THE DRAWINGS

FIG. 1 depicts an exemplary video conferencing system, in accordance with embodiments of the present invention.

FIG. 2 depicts various functional modules of the video conferencing system of FIG. 1, in accordance with embodiments of the present invention.

### DETAILED DESCRIPTION OF THE INVENTION

The present invention discloses an apparatus and associated method for a video conferencing system using an audio pickup device, such as a microphone array consisting of two microphones, and a stationary image pickup device, such as a video camera. The video conferencing system of the present invention is able to accurately detect, locate, and track a speaker using an array of only two microphones which function in combination with a stationary video camera.

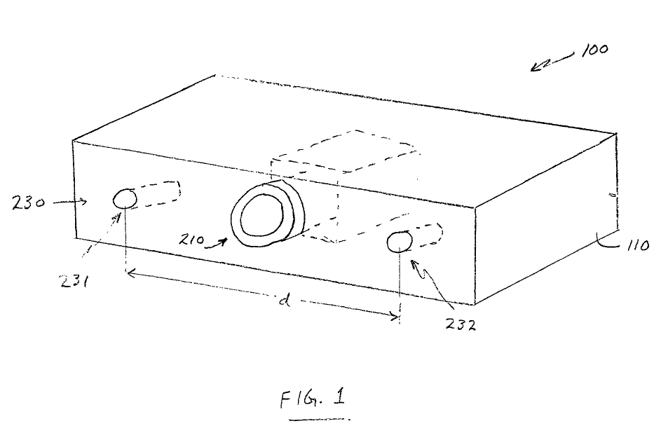

Referring now to the drawings and starting with FIG. 1, an exemplary video conferencing system 100 is shown. Video conferencing system 100 includes a stationary video camera 210 and a horizontal array of two microphones 230, which includes a first microphone 231 and a second microphone 232, positioned a predetermined distanced from one another, and fixed in a predetermined geometry.

Briefly, during operation, video conferencing system 100 receives sound waves from a human speaker (not shown) and converts the sound waves into audio signals. Video conferencing system 100 also captures video images of the speaker via stationary video camera 210. Video conferencing system 100 uses the audio signals and video images to determine a location of the speaker relative to a reference point, for example, video camera 210. Based on that direction, video conferencing system 100 can then electronically manipulate the video images to effectively pan, tilt, or zoom in or out, the video images from stationary video camera 210 to obtain a better image of the speaker.

Generally, the location of the speaker relative to video camera 210 can be characterized by two values: a direction of the speaker relative to stationary video camera 210 which may expressed as a vector, and a distance of the speaker from stationary video camera 210. As is readily apparent, the direction of the speaker relative to stationary video camera 210 can be used for effectively pointing stationary video camera 210 toward the speaker by electronically mimicking a panning or tilting operation of stationary video camera 210, and the distance of the speaker from stationary video camera 210 can be used for electronically mimicking a zooming operation stationary video camera 210.

It should be noted that in video conferencing system 100 the various components and circuits constituting video conferencing system 100 are housed within an integrated housing 110 in FIG. 1. Integrated housing 110 is designed to be able to house all of the components and circuits of video conferencing system 100. Additionally, integrated housing 110 can be sized to be readily portable by a person. In such an embodiment, the components and circuits can be designed to withstand being transported by a person and also to have “plug and play” capabilities so that the video conferencing system can be installed and used in a new environment quickly.

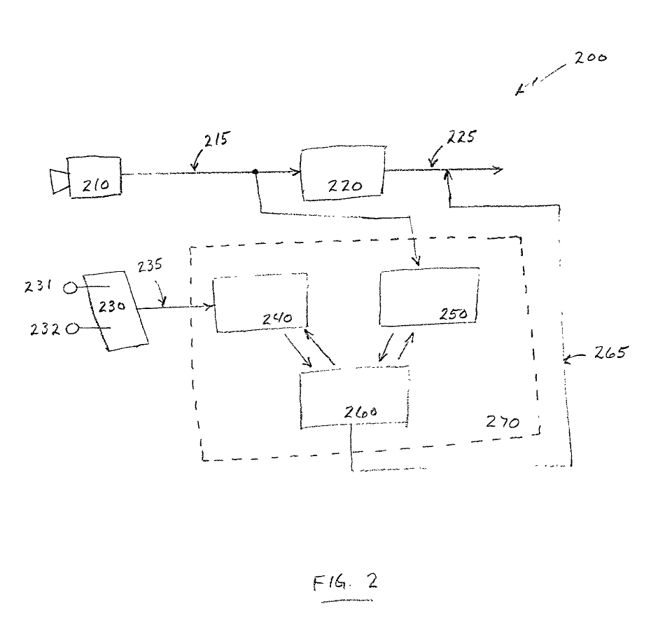

FIG. 2 schematically shows functional modules of the video conferencing system 100 of FIG. 1. Microphones 231, 232 and stationary video camera 210, respectively, supply audio signals 235 and video signals 215 to a multimodal integrated architecture module 270. Multimodal integrated architecture module 270 includes an audio source localization module 240, a computer vision person detection module 250, and a multimodal speaker detection module 260. An electronic pan tilt zoom (EPTZ) control signal is output from the multimodal speaker detection module 260 and is supplied to an electronic pan tilt zoom system module 220.

A method of operation and associated structure of a typical multimodal integrated architecture module is disclosed in (1) U.S. patent application Ser. No. 09/______,______ filed ______, 2000, entitled “Candidate-level Multimodal Integration Systems”; and (2) U.S. patent application Ser. No. 09/______,______ filed ______ , 2000, entitled “Method And Apparatus For Tracking Moving Objects Using Combined Video And Audio Information in Video Conferencing and Other Applications”, both assigned to the assignee of the present invention and incorporated by reference herein.

The stationary video camera 210 has no need for the moving parts related to known pan, tilt, or zoom operations found in a typical non-stationary video camera or a typical video camera mounting base. The pan, tilt, and zoom functions are accomplished, as necessary, by electronically mimicking these functions with the electronic pan tilt zoom system module 220. Therefore, the video conferencing system 100 of the present invention represents a high degree of simplification as compared to known video conferencing systems.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A video conferencing system comprising:
an image pickup device for generating image signals representative of an image;
an audio pickup device for generating audio signals representative of sound from an audio source; and
a multimodal integration architecture system for processing said image signals and said audio signals to determine a direction of the audio source relative to a reference point.

2. The video conferencing system of claim 1 wherein said multimodal integration
architecture
system further comprises:
an audio source localization system;
a computer vision person detection system; and
a multimodal speaker detection system.

3. The video conferencing system of claim 2, further comprising an integrated housing for an integrated video conferencing system incorporating the image pickup device, the audio pickup device, and the multimodal integration architecture system.

4. The video conferencing system of claim 3, wherein the integrated housing is sized for being portable.

5. The video conferencing system of claim 2, further comprising an electronic pan tilt zoom system for electronically manipulating the image signals to effectively provide at least one of variable pan, tilt, and zoom functions.

6. The video conferencing system of claim 5, wherein the image pickup device is a stationary camera.

7. The video conferencing system of claim 5, wherein the multimodal integrated architecture system provides control signals to the electronic pan tilt zoom system.

8. The video conferencing system of claim 7, wherein the audio source moves relative to the reference point, the audio source localization system detects the movement of the audio source, and, in response to the movement, the audio source localization system causes a change in the field of view of the image pickup device.

9. The video conferencing system of claim 5, wherein the audio pickup device is comprised of an array of two microphones.

10. A method comprising the steps of:
generating, at an image pickup device, image signals representative of an image;
generating, at an audio pickup device, audio signals representative of sound from an audio source;
processing the image signals and the audio signals to determine a direction of the audio source relative to a reference point;
manipulating the image signals to produce refined image signals; and
outputting said refined image signals.

11. The method of claim 10 further comprising the steps of:
applying said audio signals to an audio source localization system;
applying said image signals to a computer vision person detection system;
processing said audio signals and said image signals with a multimodal speaker detection system;
generating control signals based on the determined direction of the audio source;
applying the control signals to an electronic pan tilt zoom system to mimic the effect of at least one function of a movable camera, said function selected from the group consisting panning, tilting, and zooming said movable camera; and
providing an output from said electronic pan tilt zoom system.

12. The method of claim 10, further comprising electronically varying a field of view of the image pickup device in response to the control signals.

13. The method of claim 10, wherein processing the audio signals includes determining an audio based direction of the audio source based on the audio signals.

14. The method of claim 12, wherein the audio source moves relative to a reference point, and wherein processing the audio signals further includes:
detecting the movement of the audio source; and
causing electronically, in response to the movement, an increase in the field of view of the image pickup device.

15. The method of claim 12, further comprising the step of supplying control signals, based on the audio based direction, for electronically panning, tilting, or zooming said image pickup device.

16. A video conferencing system comprising:
two microphones for generating audio signals representative of sound from a speaker;
a video camera for generating video signals representative of a video image;
an electronic pan tilt zoom system for manipulating video images to produce the visual effects of panning, tilting, and/or zooming;
a processor for processing the video signals and the audio signals to determine a direction of a speaker relative to a reference point and supplying control signals to the electronic pan tilt zoom system for producing images that include the speaker in the field of view of the camera, the control signals being generated based on the determined direction of the speaker; and
a transmitter for transmitting audio and video signals for video conferencing.
